(19) United States
(12) Patent Application Publication
(10) Pub. No.: US 2006/0123352 A1
(43) Pub. Date: Jun. 8, 2006

(54) E-bible

(76) Inventor: Previs Lamar McClinton, Charlotte, NC (US)

Correspondence Address: PREVIS LAMAR McCLINTON, 4411 OAKBURN DRIVE, CHARLOTTE, NC, 28269, US

(21) Appl. No.: 10/866,262

(22) Filed: Nov. 23, 2004

(51) Int. Cl. G06F 3/00

(52) U.S. Cl. 715/776

(57) ABSTRACT

The E-BIBLE™ combines interactive software, based on the writings of various bibles, with a durable, mock-book cover, to produce a Personal digital Assistant (PDA) that resembles a standard written Bible when closed. (see FIG. 1) A mock-book cover is opened to reveal a PDA with an interactive screen, activated by the use of a plastic stylus. (see FIGS. 2 & 3) The PDA is housed inside a plastic concealment area designed to resembled pages of a book when the E-BIBLE™ is open and closed. An automatic power switch maybe be activated when the E-BIBLE™ is open and closed. This switch will regulate power from a rechargeable battery so that the unit could not be left in the “on” position when the outside cover of the E-BIBLE™ is closed and no longer in use. Opposite the electronic components housing area, on the other side of the opened E-BIBLE™, will be additional space for storage pockets, a notepad, stylus, writing instruments, and similar.

INVENTION FUNCTION: The E-BIBLE™ offers consumers a rechargeable, battery powered, hand held, electronic personal assistant with interactive software enabling a user to electronically access bible verses.

INVENTOR'S SUGGESTED MATERIAL AND COMPOMPONENTS: The E-BIBLE™ would be manufactured with numerous electrical components, interactive software, and batteries. Additional miscellaneous plastic and components will also utilized in production.

INVENTOR COMMENTS CONCERNING THEIR INVENTION: Heading into the 21^{st} century the technical advances being made in communication in data transfer are launching new products daily. Where only a short time ago, few household had the luxury of having a computer, today the home PC has become commonplace, and millions of us are utilizing a Personal Digital Assistant (PDA) on a daily basis. With advancements in electronics happening so rapidly, the American Consumers are not only open and receptive to change but they are expecting it today, conveniences sales. Any affordable electronic product that make a consumer's life easier is sure to be a success in the marketplace. With a personal desire to share in the success of technology today, while helping to bring religion from the 15^{th} century to the 21^{st}, I invented the E-BIBLE™. From a very young age, today's child is been taught to read, write, and calculate arithmetic on a computer. While Christianity has many denominations, to overall understanding of human life is summarized into “books” in a handful of different Bibles. The E-BIBLE™ is able to combine the teaching of many Bibles into one electronic book with interactive software allowing a user to locate any items out of the Bible in seconds. Not only are children of the today expecting to experience religion electronically, but also the E-BIBLE™ is ideal for the elderly. Convince, simple to use, and resembling a standard Bible, the E-BIBLE™ has the ability to magnify particular passage for easy viewing. For those experiencing difficulty in sight, the E-BIBLE™. From those experiencing difficulty in sight, the e-BIBLE™ allows a consumer to once again read the written word of the Christian Bible.

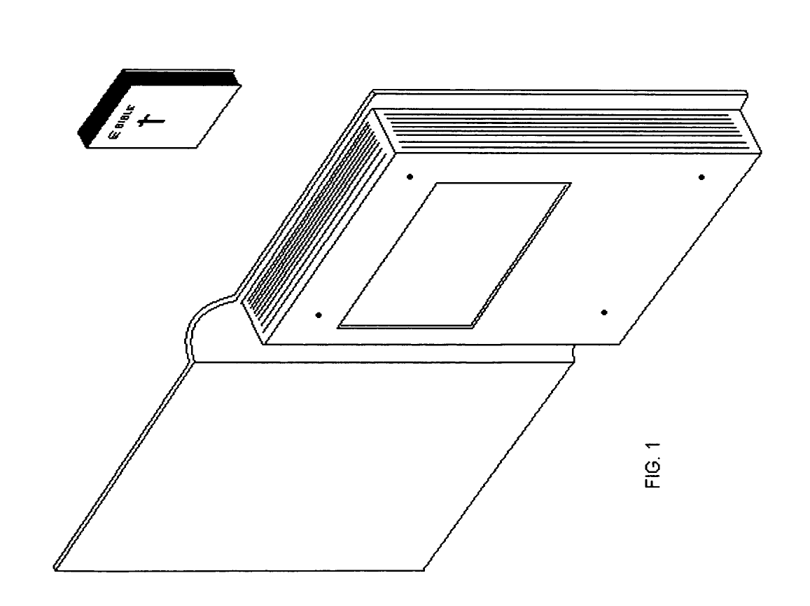

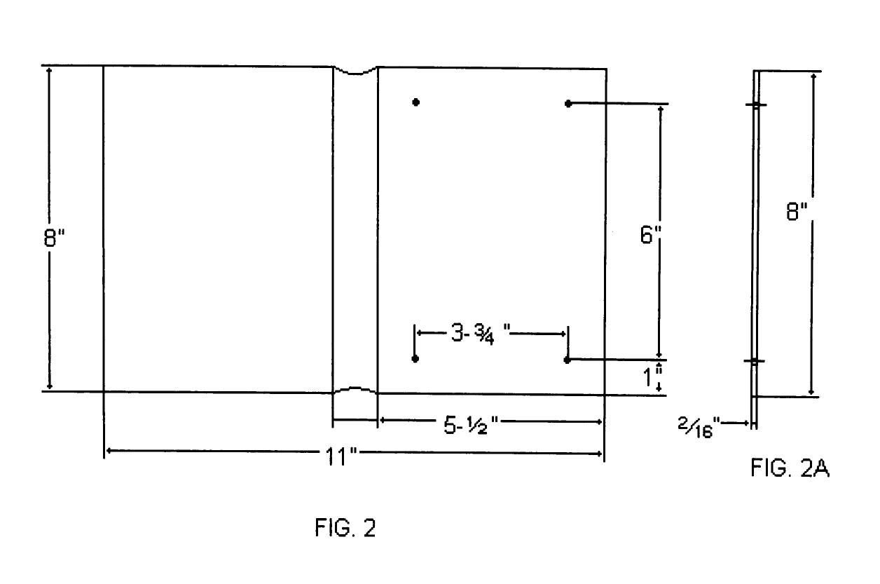

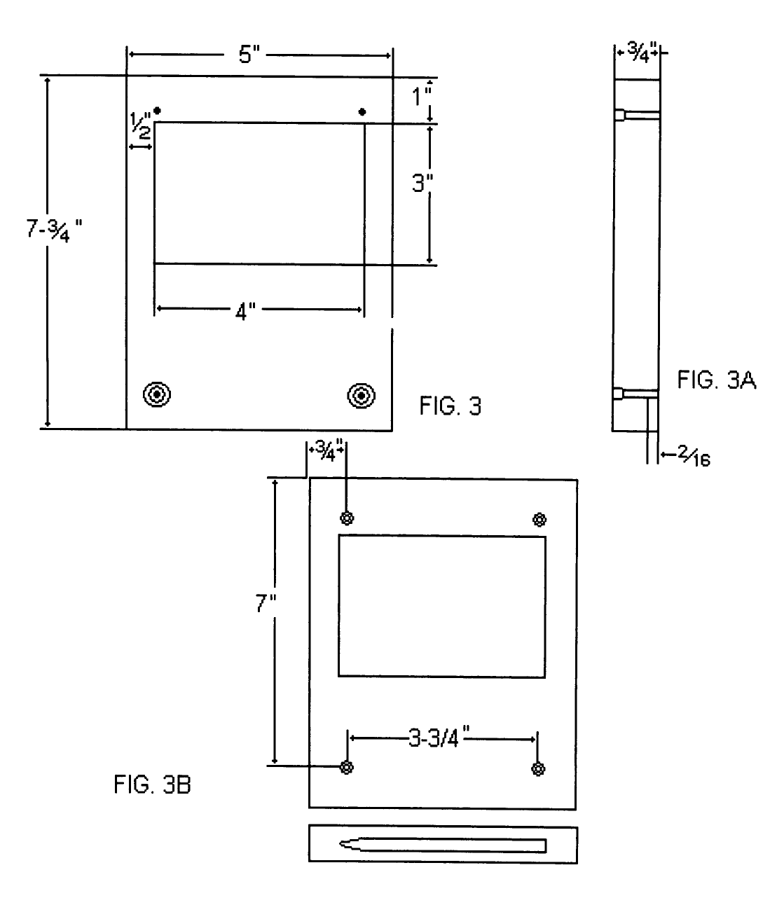

MECHANICAL DESCRIPTION: The E-BIBLE™ combines interactive software, based on the writings of various bibles, with a durable, mock-book cover, to produce a Personal digital Assistant (PDA) that resembles a standard written Bible when closed. (see FIG. 1) A mock-book cover is opened to reveal a PDA with an interactive screen, activated by the use of a plastic stylus. (see FIGS. 2 & 3) The PDA is housed inside a plastic concealment area designed to resembled pages of a book when the E-BIBLE™ is open and closed. An automatic power switch maybe be activated when the E-BIBLE™ is open and closed. This switch will regulate power from a rechargeable battery so that the unit could not be left in the “on” position when the outside cover of the E-BIBLE™ is closed and no longer in use. Opposite the electronic components housing area, on the other side of the opened E-BIBLE™, will be additional space for storage pockets, a notepad, stylus, writing instruments, and similar.

USAGE: Opening the E-BIBLE™ will turn on the E-BIBLE™ PDA located inside the mock-book cover. A user will utilize the enclosed stylus to interact with the computer program, selecting simple screen commands. The interactive software enables a user to easily locate specific Bible verses in a selected version of printed Bible. Variations to the software may exist allowing a user to spell out a particular passage on interactive keyboard, or leave notes that may be accessed at a later date. Once use of the E-BIBLE™ has commenced, a user simply closes the mock-book cover, and the unit is turned off. A rechargeable replaceable battery may supply the needed power to the E-BIBLE™.

1. I claim that the E-BIBLE™ utilizes electronic interactive software with a durable mock-book cover, resembling a standard Bible, to enable a user to electronically access Bible verses from various Bible formats.
